(19) United States
(12) Patent Application Publication
(10) Pub. No.: US 2012/0049834 A1
(43) Pub. Date: Mar. 1, 2012

(54) CIRCUIT AND METHOD TO SUPPRESS THE PARASITIC RESONANCE FROM A DC/DC CONVERTER

(75) Inventors: David Pommerenke, Rolla, MO (US); Keong Kam, Rolla, MO (US); Ankit Bhargava, Schaumburg, IL (US); Peng Shao, Rolla, MO (US); Xin Chang, Rolla, MO (US); Hongyu Li, Rolla, MO (US)

(73) Assignee: THE CURATORS OF THE UNIVERSITY OF MISSOURI, Columbia, MO (US)

(21) Appl. No.: 13/318,580

(22) PCT Filed: May 7, 2010
(86) PCT No.: PCT/US2010/034004

§ 371 Date: Nov. 2, 2011

Related U.S. Application Data
(60) Provisional application No. 61/176,409, filed on May 7, 2009.

(51) Int. Cl. G05F 3/08; H01F 41/02

(52) U.S. Cl. 323/311; 29/602.1

(57) ABSTRACT

A snubber circuit for use with a DC/DC converter broadly comprises a snubber resistor connected in parallel with a snubber inductor. The DC/DC converter may include a voltage source, a first switching element, a second switching element, an output inductor, and an output capacitor. The voltage source may include a positive terminal and a negative terminal connected to a ground node. The first switching element may include a first terminal connected to the positive terminal of the voltage source The second switching element may be connected to a second terminal of the first switching element. The series combination of the output inductor and the output capacitor may be connected between the second terminal of the first switching element and the ground node. The snubber circuit may be connected between the second switching element and the ground node.

### RELATED APPLICATION

The present application claims the priority benefit of U.S. Provisional Application No. 61/176,409, entitled “METHOD TO SUPPRESS THE PARASITIC RESONANCE IN SWITCHING CIRCUITS USING PARALLEL RESISTOR AND INDUCTOR COMBINATION,” filed May 7, 2009. The identified provisional application is incorporated herein by specific reference.

### BACKGROUND OF THE INVENTION

1. Field of the Invention

Embodiments of the present invention relate to electric voltage conversion circuits. More particularly, embodiments of the present invention relate to snubber circuits that reduce the parasitic resonance in DC/DC conversion circuits.

2. Description of the Related Art

Electric voltage conversion circuits generally convert the level of voltage from a voltage source to the level of voltage required by a load. Voltage conversion circuits may work with alternating current (AC) voltage or direct current (DC) voltage and may convert the level of voltage up, by increasing the voltage from the source to the load, or down, by decreasing the voltage from the source to the load. DC voltage to DC voltage (DC/DC) converters that convert the level of voltage down may be utilized in systems such as automotive electronics or laptop computers, wherein the voltage source may be a battery or battery pack with a level of voltage around 12 Volts (V) while the electronics or computer circuitry may operate at 5V, 3.3V, or smaller voltage levels. A simple approach to reducing the level of the source voltage may be to utilize a resistive voltage divider network. However, the voltage divider network may lack efficiency since some of the input energy is lost as heat through the resistive elements. Furthermore, the voltage to the load may vary if the level of the source voltage varies.

Another type of DC/DC converter is a synchronous buck converter which may include two switching elements, an inductor, and a capacitor. The two switching elements may be connected in series with a voltage source and may be switched on alternately with each other. The inductor may be connected in series with the capacitor and the two may be connected in parallel with one of the switching elements. The load may be connected in parallel with the capacitor. A buck converter has a relatively high efficiency and a regulated load voltage. However, when metal-oxide semiconductor field-effect transistors (MOSFETs) , for example, are utilized as the switching elements, there may be a parasitic resonance formed by the loop of the input capacitance of one MOSFET being on and conductive and the other MOSFET being off and open, thus acting as a capacitance. The parasitic resonance may cause the synchronous buck converter to have undesirable phase voltage ringing and to generate broadband noise in the 50 Megahertz (MHz) to 300 MHz range.

### SUMMARY OF THE INVENTION

Embodiments of the present invention solve the above-mentioned problems and provide a distinct advance in the art of electric voltage conversion circuits. More particularly, embodiments of the invention provide snubber circuits that reduce the parasitic resonance in DC/DC conversion circuits.

Embodiments of the present invention provide a snubber circuit for use with a DC/DC converter. The snubber circuit may broadly comprise a snubber resistor connected in parallel with a snubber inductor. The DC/DC converter may include a voltage source, a first switching element, a second switching element, an output inductor, and an output capacitor. The voltage source may include a positive terminal and a negative terminal connected to a ground node. The first switching element may include a first terminal connected to the positive terminal of the voltage source. The second switching element may be connected to a second terminal of the first switching element. The series combination of the output inductor and the output capacitor may be connected between the second terminal of the first switching element and the ground node. The snubber circuit may be connected between the second switching element and the ground node and may reduce a ringing of a voltage between the second terminal of the first switching element and the ground node.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of a direct-current (DC) voltage to DC voltage (DC/DC) converter including a synchronous buck converter circuit;

FIG. 2 is a schematic diagram of a snubber circuit constructed in accordance with various embodiments of the current invention;

FIG. 3 is a schematic diagram of various parasitic components included with the synchronous buck converter circuit;

FIG. 4 is a schematic diagram of the synchronous buck converter circuit depicting at least positions wherein the snubber circuit may be placed;

FIG. 5 is a graph of the measured voltage versus time at a phase node of the synchronous buck converter circuit;

FIG. 6 is a graph of the measured far-field noise versus frequency at the phase node of the synchronous buck converter circuit; and

FIG. 7 is a flow diagram of at least a portion of the steps of a method of forming a DC/DC converter.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

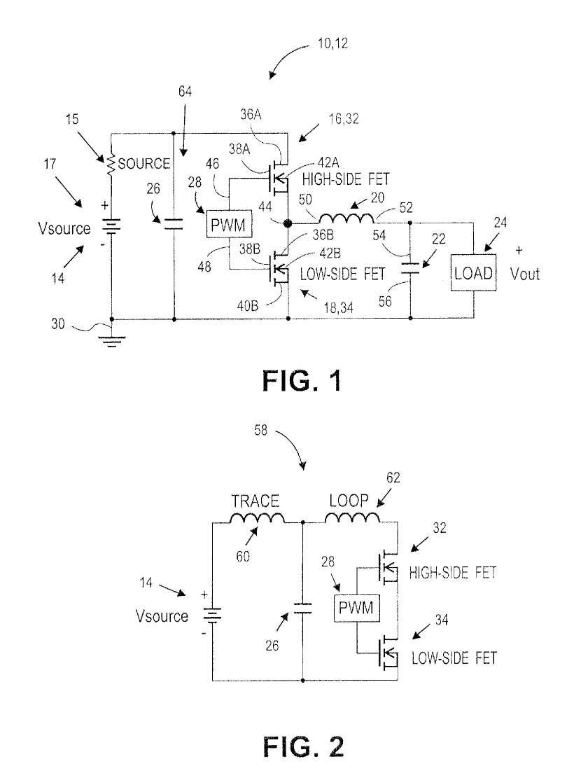

A direct-current (DC) voltage to DC voltage (DC/DC) converter 10 is shown in FIG. 1. The DC/DC converter 10 may include a synchronous buck converter circuit 12 which includes a voltage source 14, a first switching element 16, a second switching element 18, an output inductor 20, an output capacitor 22, and a load 24. The synchronous buck converter circuit 12 may also include an input decoupling capacitor 26 and a pulse-width modulation (PWM) unit 28. The synchronous buck converter circuit 12 generally provides a conversion from the level of the DC voltage of the voltage source 14 to the level of the DC voltage that is required by the load 24. Often, the synchronous buck converter circuit 12 converts the voltage level of the voltage source 14 to a lower value of voltage for the load 24.

The voltage source 14 may include a source of DC voltage. Typically, the voltage source 14 includes a portable source of DC voltage, such as a battery, as is known in the art. The voltage source 14 may include a single battery, a plurality of batteries connected either in series or in parallel, a battery pack, or the like. The voltage source 14 in practice may have a voltage level of 24 Volts (V), 12 V, or other common battery level of voltage. The voltage source 14 may include a positive terminal and a negative terminal connected to a ground node 30. The voltage source 14 may further include a source impedance 15 that includes all the impedances associated with the implementation of the voltage source 14 such as trace inductances and trace resistances.

In various embodiments, the voltage source 14 may be external to the DC/DC converter 10. In such embodiments, the synchronous buck converter circuit 12 may include an input 17 that is operable to receive the voltage from the voltage source 14. The input 17 may include a pair of electrodes or similar connection components that couple to the positive terminal and the negative terminal of the voltage source 14.

The first switching element 16 and the second switching element 18 generally include components that are capable of turning on and off or providing a closed circuit and an open circuit based on a control signal. In various embodiments, the first switching element 16 and the second switching element 18 may include an N-channel metal-oxide semiconductor field-effect transistor (MOSFET). The first switching element 16 may be presented as a high-side FET 32 in FIG. 1, and the second switching element 18 may be presented as a low-side FET 34. The high-side FET 32 may include the following terminals as are known in the art: a drain 36A, a gate 38A, a source 40A, and a bulk, body, or back gate 42A. For most embodiments, the back gate 42A may be tied to the source 40A terminal. The low-side FET 34 may include similar terminals: a drain 36B, a gate 38B, a source 40B, and a back gate 42B. Likewise, the back gate 42B may be tied to the source 40B terminal.

The drain 36A of the high-side FET 32 may be connected to the positive terminal of the voltage source 14. The source 40A of the high-side FET 32 may be connected to the drain 36B of the low-side FET as well as a phase node 44. The source 40B of the low-side FET 34 may be connected to the ground node 30.

The PWM unit 28 may provide the control signal to the first switching element 16 and the second switching element 18, and may include components, devices, or circuits, such as multivibrator or oscillator circuits, that are capable of providing an output signal that is a binary square waveform of “zeros” and “ones” at a desired frequency, as is known in the art. Furthermore, the PWM unit 28 may the capability of pulse-width modulation, which allows for adjustment of the amount of time that the output signal is a “one” compared with the total period, without changing the frequency of the output signal. This may also be known as adjusting the duty cycle of the waveform, wherein the duty cycle is the percentage of the overall period during which the waveform is a “one”. For example, a 1 megaHertz (MHz) waveform may have a period of 1 microsecond (μs). If the duty cycle is 50%, then the waveform has a value of “one” for 0.5 μs and a value of “zero” for 0.5 μs. If the duty cycle is 25%, then the waveform has a value of “one” for 0.25 μs and a value of “zero” for 0.75 μs.

The PWM unit 28 may have a high-side output 46 and a low-side output 48, which has an inverted polarity from the high-side output 46. For example, when the high-side output 46 waveform is a “one”, the low-side output 48 waveform is a “zero”, and vice versa. The high-side output 46 may be connected to the gate 38A of the high-side FET 32. The low-side output 48 may be connected to the gate 38B of the low-side FET 34. In various embodiments, the PWM unit 28 may be configured to include a small window of time (on the order of 10 nanoseconds (ns) to 40 ns) wherein both outputs 46, 48 are held at the “zero” level before either output 46, 48 is switched to the “one” level. This technique may avoid turning both the high-side FET 32 and the low-side FET 34 on at the same time, which may cause an undesirable low-resistance path to ground.

The PWM unit 28 may include circuitry to adjust the voltage levels of the high-side output 46 and the low-side output 48. The voltage levels of the “one” and “zero” of the waveform may be determined by the high-side FET 32 and the low-side FET 34. The voltage level of the “one” of the waveform may be set to a value or range of values that turn the high-side FET 32 and the low-side FET 34 on. The voltage level of the “zero” may be set to a value or range of values that turn the high-side FET 32 and the low-side FET 34 off. In addition, since the high-side FET 32 receives a signal from the PWM unit 28 that may be inverted in polarity from the low-side FET 34, the high-side FET 32 and the low-side FET 34 switch on and off alternatively. Thus, the high-side FET 32 may be on while the low-side FET 34 is off, and vice versa.

The output inductor 20 may include energy storing components whose voltage is determined by the change in current through the component. The output inductor 20 may include a discrete inductor, such as a conductive coil inductor. The output inductor 20 may include a single inductor or a plurality of inductors connected either in parallel or series and may have an inductance that depends on the load 24. In various embodiments, the inductance may range from approximately 100 nanoHenries (nH) to approximately 1 milliHenry (mH). In some embodiments, the inductance may be approximately 2.7 μH. The output inductor 20 may include a first terminal 50 connected to the phase node 44 and a second terminal 52 connected to the load 24.

The output capacitor 22 may include energy storing components whose current is determined by the change in voltage across the component. The output capacitor 22 may include a discrete capacitor of various types, such as ceramic, electrolytic, tantalum, and the like. The output capacitor 22 may include a single capacitor or a plurality of capacitors connected either in series or in parallel and may have a capacitance that depends on the load 24. In various embodiments, the output capacitor 22 includes three capacitors connected in parallel, each having a capacitance of approximately 330 microFarads (μF). The output capacitor 22 may also include a first terminal 54 connected to the second terminal 52 of the output inductor 20 and a second terminal 56 connected to the ground node 30.

The input decoupling capacitor 26 may be somewhat similar to the output capacitor 22 and may include a first terminal 72 that is connected to the positive terminal of the voltage source 14 and a second terminal 74 that is connected to the ground node 30. In various embodiments, the input decoupling capacitor 26 may include electrolytic bulk capacitors in parallel with ceramic surface-mount technology (SMT) capacitors. The electrolytic capacitors may be generally high-valued (greater than 100 μF) and may be used to decouple low-frequency switching noise, typically ranging from approximately 100 kiloHertz (kHz) to approximately 300 kHz and harmonics thereof. In some embodiments, the electrolytic capacitors may include two capacitors in parallel, each with a capacitance of approximately 470 μF. The ceramic SMT capacitors may be positioned closer to the high-side FET 32 and the low-side FET 34 and may provide high-frequency current corresponding to the rise and fall times of the PWM unit 28 waveform, which may be greater than 30 MHz. In some embodiments, the ceramic SMT capacitor may include a capacitor with a capacitance of 1 μF.

The load 24 may be connected across the first terminal 54 and the second terminal 56 of the output capacitor 22. The load 24 may include any component, element, device, circuit, or the like, and combinations thereof that require a DC voltage. Generally, the voltage level required by the load 24 is less than the voltage level supplied by the voltage source 14. Examples of the load 24 may include automotive electronic circuitry, laptop computers, palmtop computers, cell phones, or other small-scale or handheld electronic devices. Common voltage values for electronic circuitry and devices may include approximately 5 V, approximately 3.3 V, or lower voltage values.

The synchronous buck converter circuit 12 may operate as briefly described. The PWM unit 28 may generate a square wave signal with a given period through the high-side output 46 and the inverse of the signal to the low-side output 48. For a first portion of the period, the high-side FET is on and the low-side FET 34 is off. Current flows from the voltage source 14 to supply current to the load 24 and to store energy in the output inductor 20 and the output capacitor 22. A voltage is developed across the load 24. For a second portion of the period, the high-side FET 32 is off and the low-side FET is on. Current no longer flows from the voltage source 14 to the load 24. Instead, current may flow to the load 24 from the output inductor 20, the output capacitor 22, or both, and the voltage across the load 24 is maintained. The process continues as the PWM unit 28 continues to generate the square wave signal.

The voltage across the load 24 may be determined by the duty cycle (D) of the square wave signal from the PWM unit 28, such that Vout=Vsource×D, wherein Vout is the voltage across the load 24, Vsource is the voltage of the voltage source 14, and D is the duty cycle in terms of percent. Thus, the duty cycle may be adjusted to control the level of the output voltage. For example, if the source voltage is 12 V and the desired output voltage is 1.2 V, then the duty cycle is 10%.

The components utilized in the synchronous buck converter circuit 12 may naturally possess certain parasitic inductances and capacitances (LC). When the synchronous buck converter circuit 12 is operating, the parasitic inductances and capacitances, particularly the high-side FET 32, the low-side FET 34, and the input decoupling capacitor 26 (which collectively form a switching loop 64), may cause a parasitic LC resonance, that in turn causes undesirable ringing or voltage oscillation at the phase node 44. The frequency of the ringing may coincide with the frequency of the parasitic LC resonance. The ringing may also generate broadband noise which may prevent an electronic device or system that includes the synchronous buck converter circuit 12 from passing regulatory electromagnetic compatibility requirements. The noise may also affect other parts of the device or system.

To illustrate and study the parasitic LC resonance, the synchronous buck converter circuit 12 was implemented on a printed circuit board (PCB). Some of the components of the synchronous buck converter circuit 12 along with parasitic inductances are shown in a model circuit 58 in FIG. 2. The model circuit 58 may include a trace inductor 60 that is modeled from the conductive traces on the PCB in addition to a loop inductor 62 that is modeled on the inductance of the switching loop 64. Other embodiments of the model circuit 58 may include additional parasitic components.

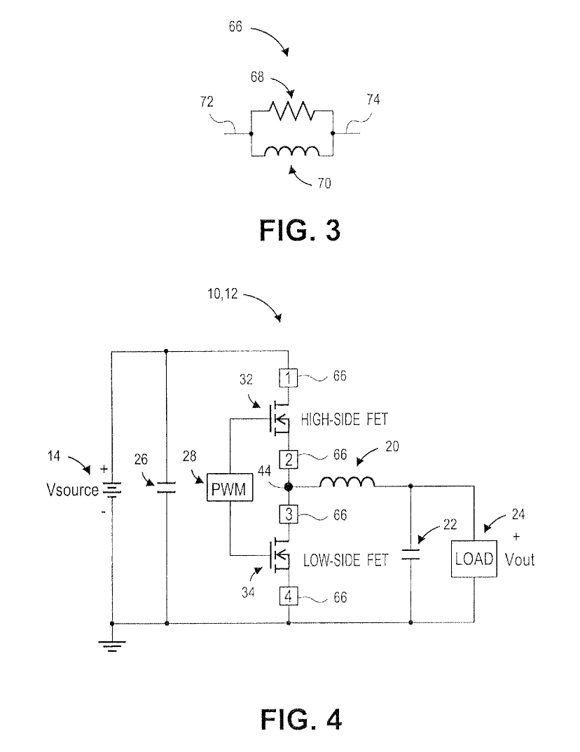

In order to counter and reduce the detrimental effects of the parasitic LC resonance, a snubber circuit 66 constructed in accordance with various embodiments of the current invention may be connected to the synchronous buck converter circuit 12. The snubber circuit 66 may broadly comprise a snubber resistor 68 connected in parallel with a snubber inductor 70 as shown in FIG. 3. The snubber circuit 66 may also include a first terminal 72 and a second terminal 74.

The snubber resistor 68 may generally include electrically resistive components, or resistors, as are known in the art. The snubber resistor 68 may include a single resistor or a plurality of resistors connected either in series or in parallel. The snubber resistor 68 may include discrete carbon composition or carbon film resistor, SMT resistors, PCB conductive trace resistors, or combinations thereof. In various embodiments, the resistance of the snubber resistor 68 may range from approximately 0.5 ohm (Ω) to approximately 2 Ω.

The snubber inductor 70 may be implemented as a discrete inductor or as a PCB conductive trace. The implementation as a PCB conductive trace may be optimally effective if the parasitic inductance of the switching loop 64 is a minimum. For example, if the switching loop 64 components of the input decoupling capacitor 26, the high-side FET 32, and the low-side FET 34 are implemented on the top layer of a PCB and the second layer is a solid ground plane at a narrow distance, such as 0.1 millimeters (mm), then the parasitic inductance of the switching loop 64 may range from approximately 1.5 nanoHenries (nH) to approximately 10 nH. Thus, in order to counter the resulting resonance, the snubber inductor 70 may have an inductance that is less than 5 nH. In some embodiments, the inductance of the snubber inductor 70 may be approximately 2.5 nH.

The snubber circuit 66 may be connected to the synchronous buck converter circuit 12 in at least four positions, as indicated by the boxes numbered 1 through 4 in FIG. 4. In a first embodiment of the synchronous buck converter circuit 12, the first terminal 72 of the snubber circuit 66 may be connected to the positive terminal of the voltage source 14, and the second terminal 74 may be connected to the drain 36A of the high-side FET 32. In a second embodiment of the synchronous buck converter circuit 12, the first terminal 72 of the snubber circuit 66 may be connected to the source 40A of the high-side FET 32, and the second terminal 74 may be connected to the drain 36B of the low-side FET 34 and the first terminal 50 of the output inductor 20. In a third embodiment of the synchronous buck converter circuit 12, the first terminal 72 of the snubber circuit 66 may be connected to the source 40A of the high-side FET 32 and the first terminal 50 of the output inductor 20, and the second terminal 74 may be connected to the drain 36B of the low-side FET 34. In a fourth embodiment of the synchronous buck converter circuit 12, the first terminal 72 of the snubber circuit 66 may be connected to the source 40B of the low-side FET 34, and the second terminal 74 may be connected to the ground node 30.

The snubber circuit 66 was implemented with the synchronous buck converter circuit 12 on the PCB and connected in the four positions discussed above. There were also two embodiments of the snubber circuit 66 used. The first embodiment of the snubber circuit 66 included a 2.5 nH discrete snubber inductor 70 and a 0.733 Ω snubber resistor 68. The second embodiment of the snubber circuit 66 included a 6.5 nH snubber inductor 70 implemented as a conductive PCB trace and a 1.1 Ω snubber resistor 68.

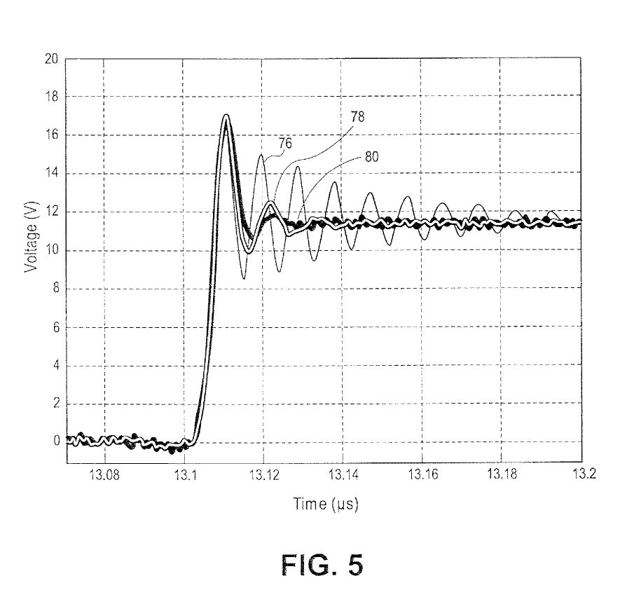

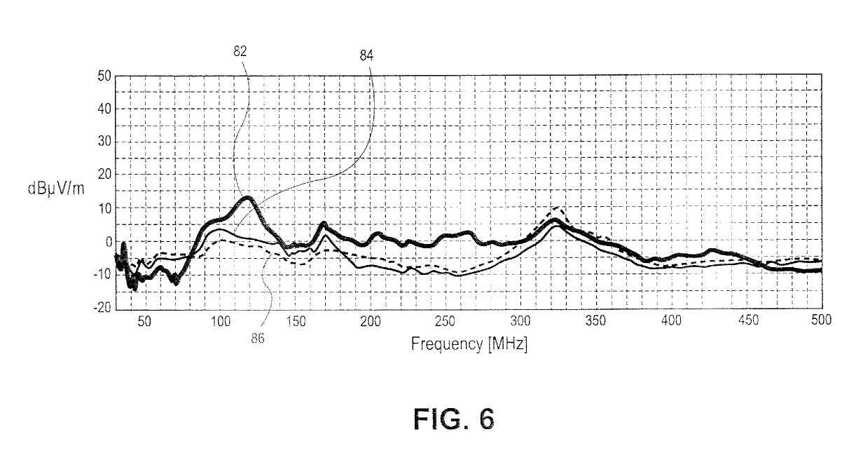

The performance of the synchronous buck converter circuit 12 without the snubber circuit 66 and with the two embodiments of the snubber circuit 66 may be shown in FIGS. 5-6. The measured voltage versus time at the phase node 44 of the implemented synchronous buck converter circuit 12 is shown in FIG. 5. A first plot 76 may indicate the voltage of the phase node 44 with no snubber circuit 66. As can be seen, the first plot 76 shows significant ringing that slowly decays over time. A second plot 78 may indicate the voltage of the phase node 44 with the first embodiment (2.5 nH+0.733 Ω) of the snubber circuit 66. The second plot 78 shows a reduction in the amplitude of the ringing of the phase node 44 voltage. A third plot 80 may indicate the voltage of the phase node 44 with the second embodiment (6.5 nH PCB trace+1.1 Ω) of the snubber circuit 66. The third plot 80 shows even greater damping of the phase node 44 voltage ringing as compared with the performance of the first embodiment of the snubber circuit 66.

The measured far-field noise of the synchronous buck converter circuit 12 in terms of decibel microVolt per meter (dBμV/m) versus frequency in terms of megaHertz (MHz) is shown in FIG. 6. A first plot 82 shows the noise with no snubber circuit 66 included with the synchronous buck converter circuit 12. There is a peak in the noise of the first plot 82 at approximately 120 MHz. A second plot 84 shows the noise with the first embodiment (2.5 nH+0.733 Ω) of the snubber circuit 66. The second plot 84 shows a significant reduction in the noise at approximately 120 MHz. A third plot 86 shows the noise with the second embodiment (6.5 nH PCB trace+1.1 Ω) of the snubber circuit 66. The third plot 86 shows an even greater reduction in the noise generated at approximately 120 MHz. Both embodiments of the snubber circuit 66 provide a 10-13 dB reduction in the far-field noise at approximately 120 MHz.

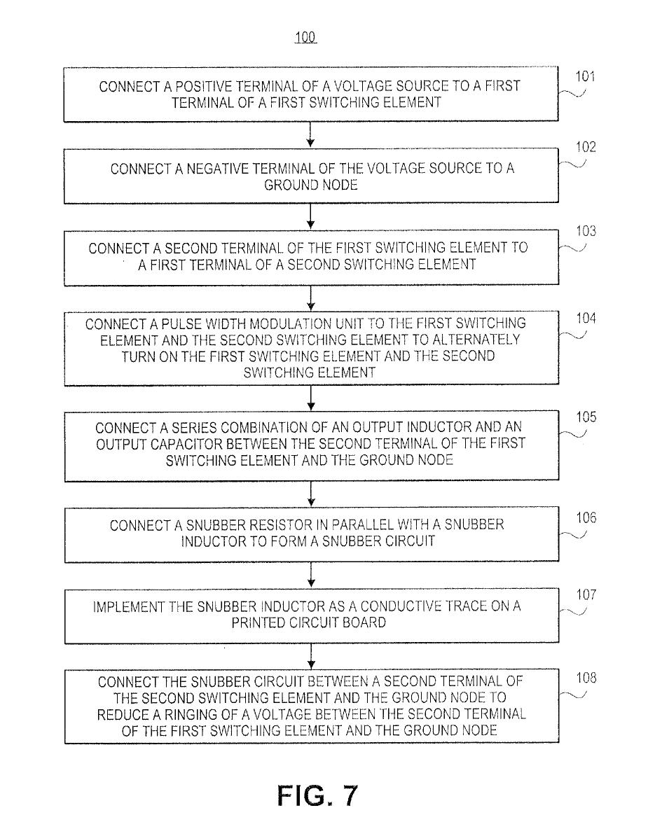

At least a portion of the steps of a method 100 of forming a DC/DC converter 10 in accordance with various embodiments of the present invention is listed in FIG. 7. The steps may be performed in the order as shown in FIG. 7, or they may be performed in a different order. Furthermore, some steps may be performed concurrently as opposed to sequentially. In addition, some steps may be omitted.

In connection with step 101, a positive terminal of a voltage source 14 may be connected to a first terminal of a first switching element 16. In various embodiments, the first switching element 16 may include a metal-oxide semiconductor field-effect transistor (MOSFET), presented as a high-side FET 32, with a drain 36A coupled to the first terminal, a gate 38A, and a source 40A.

In connection with step 102, a negative terminal of the voltage source 14 may be connected to a ground node 30.

In connection with step 103, a second terminal of the first switching element 16 may be connected to a first terminal of a second switching element 18. The second terminal of the first switching element 16 may be coupled to the source 40A of the high-side FET 32. The second switching element 18 may include a MOSFET presented as a low-side FET 34 with a drain 36B coupled to the first terminal, a gate 38B, and a source 40B.

In connection with step 104, a pulse width modulation (PWM) unit 28 may be connected to the first switching element 16 and the second switching element 18 to alternately turn on the first switching element 16 and the second switching element 18. The PWM unit 28 may be connected to the gate 38A of the high-side FET 32 and the gate 38B of the low-side FET 34. The PWM unit 28 may turn on the high-side FET 32 while the low-side FET 34 is off and may turn on the low-side FET 34 while the high-side FET 32 is off.

In connection with step 105, a series combination of an output inductor 20 and an output capacitor 22 may be connected between the second terminal of the first switching element 16 and the ground node 30. The output inductor 20 may be connected to the source 40A of the high-side FET 32. The output capacitor 22 may be connected to the ground node 30.

In connection with step 106, a snubber resistor 68 may be connected in parallel with a snubber inductor 70 to form a snubber circuit 66. The snubber inductor 70 may have an inductance of less than five nanoHenries. In connection with step 107, the snubber inductor 70 may be implemented as a conductive trace on a printed circuit board.

In connection with step 108, the snubber circuit 66 may be connected between a second terminal of the second switching element 18 and the ground node 30 to reduce a ringing of a voltage between the second terminal of the first switching element 16 and the ground node 30. The snubber circuit 66 may be connected between the source 40B of the low-side FET 34 and the ground node 30. The node where the source 40A of the high-side FET 32 is connected to the drain 36B of the low-side FET 34 may also be known as the phase node 44. The snubber circuit 66 may provide a reduction in the ringing of the voltage at the phase node 44.

The snubber circuit 66 may serve to lower the peak voltage between the phase node 44 and ground node 30, which in turn lowers the voltage stress on the high-side FET 32. Thus, the high-side FET 32 may possess a lower voltage withstand capability and a smaller drain-source resistance when the high-side FET 32 is on. As a result, the efficiency of the DC/DC converter 10 may increase.

When the snubber circuit 66 is placed in the fourth position as shown in FIG. 4, a voltage may develop across the snubber circuit 66 for a moment, which adds to the voltage from the gate 38B of the low-side FET 34 to the ground node 30. As a result, it is more unlikely that current injection into the gate 38B of the low-side FET 34 from the drain-gate capacitance may turn the low-side FET 34 on. Thus, efficiency may increase as the guard time may be reduced and shoot-through current may be reduced.

Embodiments of the snubber circuit 66 disclosed herein may provide an advantage over conventional RC snubber circuits. As the parasitic inductance of the switching loop 64 is minimized, the parasitic inductance may approach the value of the parasitic inductance of the RC snubber circuit. In such cases, the RC snubber circuit may act as an RLC circuit, thereby making it difficult to determine the optimal values for R and C. In contrast, the values of the snubber resistor 68 and the snubber inductor 70 of the snubber circuit 66 disclosed herein may be easily determined provided the loss of the output capacitor 22 is known. Particularly, the value of the snubber inductor 70 may be simply determined, as it may be a fraction of the parasitic inductance of the switching loop 64. Furthermore, in order to function properly, the RC snubber must be connected between the phase node 44 and the ground node 30. The snubber circuit 66 disclosed herein may be connected in any of the four positions discussed above.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A DC/DC converter circuit comprising:
an input for receiving voltage from a voltage source, the input including a positive terminal and a negative terminal connected to a ground node;
an input capacitor connected in parallel with the input;
a first switching element with a first terminal connected to the positive terminal of the input;
a second switching element connected to a second terminal of the first switching element;
an output inductor;
an output capacitor connected in series with the output inductor, the combination of the output inductor and the output capacitor connected from the second terminal of the first switching element to the ground node; and
a snubber circuit including a snubber resistor connected in parallel with a snubber inductor, the snubber circuit connected in series with the input capacitor, the first switching element, the second switching element, and the ground node to reduce a ringing of a voltage between the second terminal of the first switching element and the ground node.

2. The DC/DC converter circuit of claim 1, wherein the snubber inductor has an inductance less than five nanoHenries.

3. The DC/DC converter circuit of claim 1, wherein the snubber inductor is implemented as a conductive trace of a printed circuit board.

4. The DC/DC converter circuit of claim 1, wherein the second switching element is a metal-oxide semiconductor field-effect transistor including a drain connected to the second terminal of the first switching element, a gate, and a source, such that the snubber circuit is connected between the source and the ground node.

5. The DC/DC converter circuit of claim 4, wherein the first switching element is a metal-oxide semiconductor field-effect transistor including a drain coupled with the first terminal, a gate, and a source coupled with the second terminal.

6. The DC/DC converter circuit of claim 1, further including a pulse-width modulation unit operable to turn the first switching element on while the second switching element is off and to turn the second switching element on while the first switching element is off.

7. The DC/DC converter circuit of claim 1, wherein the snubber circuit is connected between the second switching element and the ground node.

8. A DC/DC converter circuit comprising:
an input for receiving voltage from a voltage source, the input including a positive terminal and a negative terminal connected to a ground node;
a first metal-oxide semiconductor field-effect transistor (MOSFET) including a drain, a gate, and a source, wherein the drain is connected to the positive terminal of the input;
a second MOSFET including a drain, a gate, and a source, wherein the drain is connected to the source of the first MOSFET;
an output inductor;
an output capacitor connected in series with the output inductor, the combination of the output inductor and the output capacitor connected from the source of the first MOSFET to the ground node; and
a snubber circuit including a snubber resistor connected in parallel with a snubber inductor having an inductance of less than five nanoHenries and implemented as a trace of a printed circuit board, the snubber circuit connected between the source of the second MOSFET and the ground node to reduce a ringing of a voltage between the source of the first MOSFET and the ground node.

9. The DC/DC converter circuit of claim 8, further including a pulse-width modulation unit connected to the gate of the first MOSFET and the gate of the second MOSFET, the pulse-width modulation unit operable to turn the first MOSFET on while the second MOSFET is off and to turn the second MOSFET on while the first MOSFET is off.

10. The DC/DC converter circuit of claim 8, further including an input capacitor connected in parallel with the input.

11. A method of forming a DC/DC converter, the method comprising the steps of:
a) connecting a positive terminal of an input to receive voltage from a voltage source to a first terminal of a first switching element;
b) connecting a negative terminal of the input to a ground node;
c) connecting a second terminal of the first switching element to a first terminal of a second switching element;
d) connecting a series combination of an output inductor and an output capacitor between the second terminal of the first switching element and the ground node;
e) connecting a snubber resistor in parallel with a snubber inductor to form a snubber circuit; and
f) connecting the snubber circuit between a second terminal of the second switching element and the ground node to reduce a ringing of a voltage between the second terminal of the first switching element and the ground node.

12. The method of claim 11, further including the step of connecting a pulse width modulation unit to the first switching element and the second switching element to alternately turn on the first switching element and the second switching element.

13. The method of claim 11, further including the step of implementing the snubber inductor as a conductive trace on a printed circuit board.

14. The method of claim 11, wherein the snubber inductor has an inductance of less than 5 nanoHenries.

15. The method of claim 11, wherein the second switching element is a metal-oxide semiconductor field-effect transistor including a drain connected to the second terminal of the first switching element, a gate, and a source, such that the snubber circuit is connected between the source and the ground node.

16. The method of claim 15, wherein the first switching element is a metal-oxide semiconductor field-effect transistor including a drain coupled with the first terminal, a gate, and a source coupled with the second terminal.
